(19) United States
(12) Patent Application Publication
(10) Pub. No.: US 2007/0192802 A1
(43) Pub. Date: Aug. 16, 2007

(54) Method for Utilizing a Media Adapter to Manage Multimedia Data Stored in a Plurality of Multimedia Sources

(76) Inventors: Shu-Yi Chen, Taipei City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/567,724

(22) Filed: Dec. 6, 2006

(30) Foreign Application Priority Data
Feb. 10, 2006 (TW) 095104597

(51) Int. Cl. H04N 5/445; G06F 13/00

(52) U.S. Cl. 725/59

(57) ABSTRACT

A method for utilizing a media adapter to manage multimedia data stored in a plurality of multimedia sources includes: the media adapter receiving an user access data; obtaining access corresponding to the user access data; setting the access corresponding to the user access data of the plurality of multimedia sources; comparing access corresponding to the user access data of the multimedia data stored in the plurality of multimedia sources with access corresponding to the user access data received by the media adapter; and the media adapter respectively managing the multimedia data stored in the plurality of multimedia sources according to a comparison result. The method allows a user to login to different multimedia sources by utilizing a user access data.

### BACKGROUND OF THE INVENTION

1. Field of the Invention

The present invention relates to a method for utilizing a media adapter to manage multimedia data stored in a plurality of multimedia sources and related media adapter, and more particularly, to a method for utilizing a media adapter to compare access corresponding to a user access data of a plurality of multimedia sources received by a receiving module that is stored in a memory with access corresponding to a user access data received by the media adapter, and to manage multimedia data stored in the plurality of multimedia sources.

2. Description of the Prior Art

A characteristic of a media adapter is that the media adapter can convert movies and image files stored on computers, hard disks, or media servers, such as: media programs, audio files, movies, and pictures in a wireless manner for a user to watch and listen to on traditional or digital televisions and sound systems.

Please refer to FIG. 1. FIG. 1 illustrates a diagram of a conventional media adapter 10 converting multimedia data of a plurality of multimedia sources 12 to a display device 14. The multimedia source 12 can be a computer, a hard disk, or a media server. The multimedia data stored in the multimedia source 12 can be a media program, an audio file, a movie, or a picture. The display device 14 can be a television. The multimedia source 12 can transmit the multimedia data stored in the multimedia source 12 to the media adapter 10 in a wired or wireless manner. The media adapter 10 can be utilized for decoding the multimedia data transmitted from the plurality of multimedia sources to generate a signal that is receivable by the display device 14. The signal is then transmitted to the display device 14 in a wired or wireless manner so that the user can listen to and watch the multimedia data on the display device 14.

However, a multimedia source 12 can often be a computer owned by a person who is not the current user. For example, a multimedia source 12 in a household can be a computer that belongs to a parent or a child of the household, and a user of the multimedia source 12 may want to enjoy a portion of multimedia data stored in the multimedia source 12, but due to the confidentiality of the multimedia data, the user may not wish the multimedia data to be watched by other users through the media adapter 10. In a conventional method, a user is required to input a user access data set by each multimedia source 12 in order to login to each multimedia source 12 to manage the corresponding multimedia source 12 according to access of the user access data. However, the disadvantage of the method lies in the action of the user having to respectively login to a corresponding multimedia source 12 by utilizing a specific user access data of each multimedia source 12 in order to manage the multimedia source 12. Unless a unified user access data is set to each corresponding multimedia source 12 end, for example, an access of a unified user access data is being set in each corresponding multimedia source 12, and the user is only required to input the user access data to the media adapter 10 to respectively login to each multimedia source 12, hence the user can watch or listen to the multimedia data corresponding to the access of the user access data in each multimedia source 12. Regarding access, categories such as: restricted, mature audience, parental guidance, general viewing, etc. can be used. But in reality, the method proves to be quite impractical, because a multimedia source 12 is often managed by different users, thus the user access data of each multimedia source 12 will not be the same. For example, problems result when a unified user access data is to be set on each multimedia source 12. Firstly, this action will cause inconvenience to other users managing the multimedia source 12. Secondly, time and effort is needed to set the unified user access data on each multimedia source 12. Hence, the conventional method lacks innovation in utilizing the media adapter 10 to manage multimedia data stored in the multimedia source 12.

### SUMMARY OF THE INVENTION

It is therefore one of the objectives of the claimed invention to provide a method for utilizing a media adapter to access multimedia data stored in a plurality of multimedia sources and the related apparatus thereof to solve the above mentioned problem.

According to an embodiment of the claimed invention, a method for utilizing a media adapter to access multimedia data stored in a plurality of multimedia sources is disclosed. The method includes: the media adapter receiving an user access data; obtaining access corresponding to the user access data; setting the access corresponding to the user access data of the plurality of multimedia sources; comparing access corresponding to the user access data of the multimedia data stored in the plurality of multimedia sources with access corresponding to the user access data received by the media adapter; and the media adapter respectively managing the multimedia data stored in the plurality of multimedia sources according to a comparison result.

According to an embodiment of the claimed invention, a media adapter capable of accessing multimedia data stored in a plurality of multimedia sources is disclosed. The media adapter comprises: an input module, a receiving module, a memory, and a control device. The input interface is to input user access data. The receiving module is to receive the user access data and corresponding access data transmitted from the plurality of multimedia sources. The memory is to store the user access data and the corresponding user access data. The control device is to compare access corresponding to the user access data of the plurality of multimedia sources received by the receiving module stored in the memory with access corresponding to the user access data inputted by the input interface, and the control device is to log in to manage the multimedia data stored in the plurality of multimedia sources according to a comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional media adapter according to the prior art.

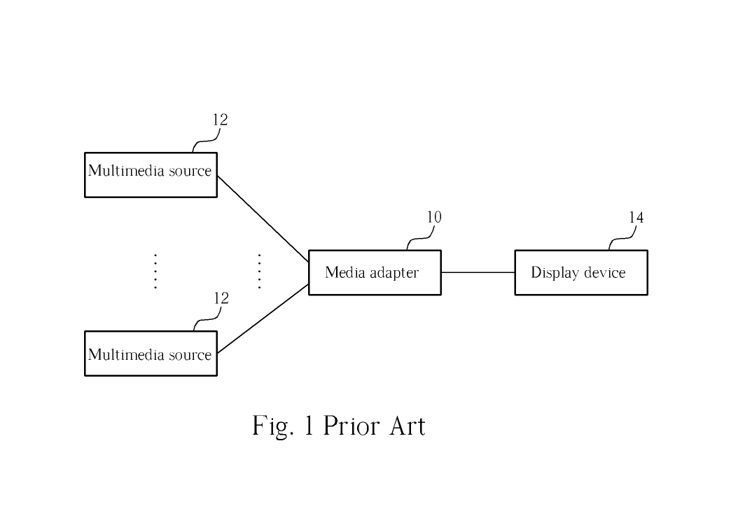

FIG. 2 is a functional block diagram of a media adapter according to an embodiment of the present invention.

FIG. 3 is a flowchart illustrating a method of managing multimedia data stored in a plurality of multimedia sources according to an embodiment of the present invention.

FIG. 4 is a diagram of file information of multimedia data of a multimedia source according to an embodiment of the present invention.

FIG. 5 is a diagram of access according to the user access data of the multimedia source of FIG. 4 according to an embodiment of the present invention.

FIG. 6 is a diagram of an input interface receiving a user access data and its corresponding access according to an embodiment of the present invention.

### DETAILED DESCRIPTION

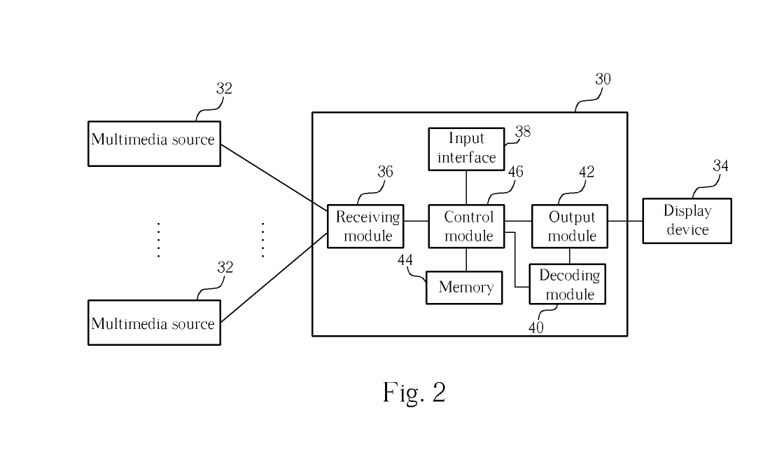

Please refer to FIG. 2. FIG. 2 illustrates a functional block diagram of a media adapter 30 converting multimedia data stored in a plurality of multimedia sources 32 to a display device 34. The multimedia source 32 can be a computer, a hard disk, a media server, or a DVD player. The multimedia data stored in the multimedia source 32 can be a media program, an audio file, a movie, or a picture. The display device 14 can be a television. The media adapter 30 includes a receiving module 36 for receiving user access data of multimedia data and the multimedia data transmitted from the plurality of multimedia sources 32, where the receiving module 36 can receive data transmitted from the plurality of multimedia sources 32 in a wired or wireless manner. The media adapter 30 further includes an input interface 38 for inputting user access data, or for a user to set access corresponding to the user access data of the multimedia data stored in the plurality of multimedia sources; or for the user to determine service items provided by the plurality of multimedia sources 32. The input interface 38 can be an on screen display (OSD). The media adapter 30 further includes a decoding module 40 for decoding the multimedia data received by the receiving module 36 to generate signals receivable by the display device 34. An output module 42, coupled to the decoding module 40, is for outputting the signals generated by the decoding module 40 to the display device 34. A memory 44 is for storing each user access data and corresponding access. Finally, a control device 46 is coupled to the receiving module 36, the input interface 38, the decoding module 40, the output module 42, and the memory 44. The control device 46 is for comparing the access corresponding to the user access data of the plurality of multimedia source 42 received by the receiving module 36 that is stored in the memory 44 with the access corresponding to the user access data inputted by the input interface 38. Additionally, the control device 46 is for logging in to manage the multimedia data stored in the plurality of multimedia sources 32 according to a comparison result. The control device 46 can be presented in a software or hardware method. The multimedia source 32 can transmit the multimedia data stored in the multimedia source 32 to the receiving module 36 of the media adapter 30 in a wired or wireless manner. The decoding module 40 of the media adapter 30 can be utilized for decoding the multimedia data transmitted from the plurality of multimedia sources 32 to generate signal receivable by the display device 34, and for utilizing the output module 42 to transmit the signals to the display device 34 in a wired or wireless manner so that the user can listen to and watch multimedia data on the display device 34.

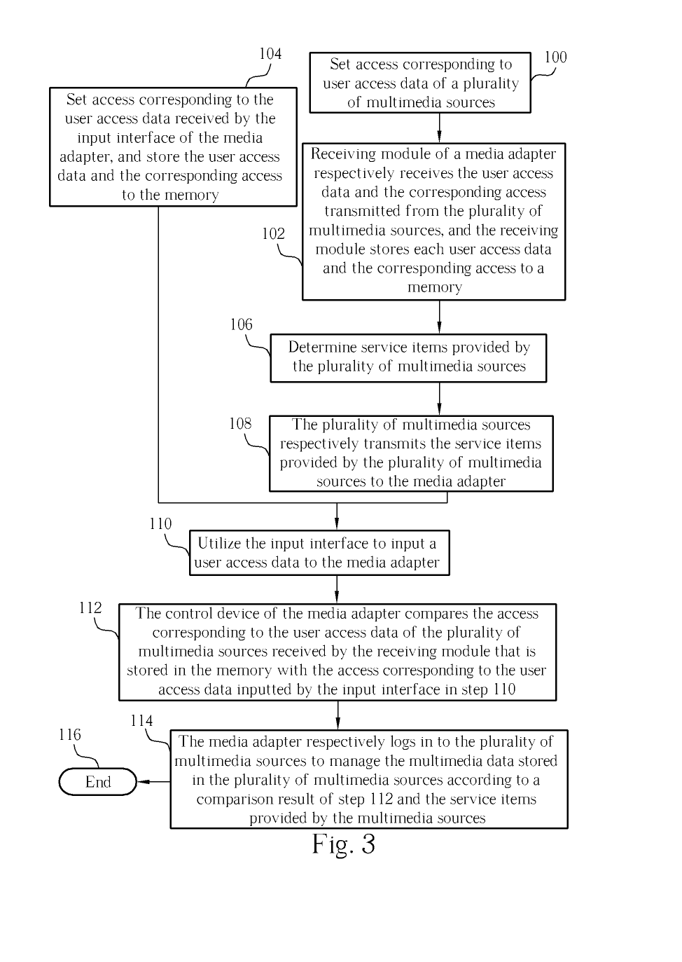

Please refer to FIG. 3. FIG. 3 illustrates a flowchart of utilizing a media adapter 30 to manage multimedia data stored in a plurality of multimedia sources 32. The method includes the following steps:

Step 100: set access corresponding to the user access data of the plurality of multimedia sources;

Step 102: the receiving module 36 of the media adapter 30 respectively receives the user access data and the corresponding access transmitted from the plurality of multimedia sources 32, and the receiving module 36 stores each user access data and the corresponding access to the memory 44;

Step 104: set access corresponding to the user access data received by the input interface 38 of the media adapter 30, and store the user access data and the corresponding access to the memory 44;

Step 106: determine service items provided by the plurality of multimedia sources 32;

Step 108: the plurality of multimedia sources 32 respectively transmits the service items provided by the plurality of multimedia sources 32 to the media adapter 30;

Step 110: utilize the input interface 38 to input a user access data to the media adapter 30;

Step 112: the control device 46 of the media adapter 30 compares the access corresponding to the user access data of the plurality of multimedia sources 32 received by the receiving module 36 that is stored in the memory with the access corresponding to the user access data inputted by the input interface 38 in step 110;

Step 114: the media adapter 30 respectively logs in to the plurality of multimedia sources 32 to manage the multimedia data stored in the plurality of multimedia sources 32 according to a comparison result of step 112 and the service items provided by the multimedia sources 32; and

Step 116: end.

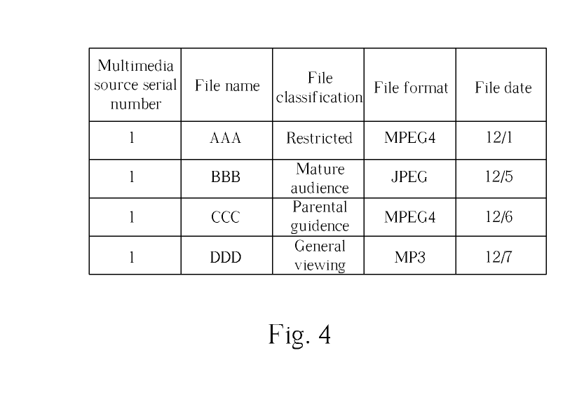

The following example is provided to further explain the above-mentioned steps. First, the user, for example, sets the access corresponding to the user access data of the plurality of multimedia sources 32, where the user access data can include user name and password, and the setting method can be achieved by directly setting the access corresponding to the user access data at the multimedia source 32 end, or by setting the access corresponding the user access data of the plurality of multimedia sources 32 through the input interface 38 of the media adapter 30. The access corresponding to the user access data can be manageable access categories/classification of the multimedia data stored in the multimedia source 32, such as: browsing access, editing access, and so forth. For example, please refer to FIG. 4. FIG. 4 illustrates a diagram of file information of multimedia data of a multimedia source 32. The file information includes serial number of the multimedia source 32, file name of the multimedia data, file classification of the multimedia data, file format of the multimedia data, and file date of the multimedia data. The file classification of the multimedia data includes categories such as, for example: restricted, mature audience, parental guidance, and general viewing. The classification of the multimedia data can be set according to for example, the TV parental guidelines system of the United States. In other words, the multimedia data having been classified with the general viewing category can be viewed by a general audience, the parental guidance category is associated with a program not suitable for young children, the mature audience category is associated with a program that is not intended for and should not be viewed by audiences under the age of 17, and finally, the restricted category is associated with a program that can only be viewed by audiences above the age of 18. However, the TV parental guidelines system of the United States is provided by way of example and not a limitation of the present invention. Classification data of the multimedia data can be set according to the user's requirement in the same way as previously described, and hence the details of this will not be reiterated.

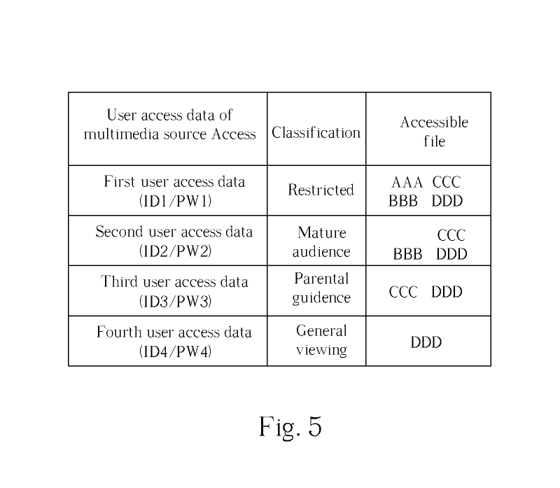

Please refer to FIG. 5. FIG. 5 illustrates a diagram of access according to the user access data of the multimedia source 32 of FIG. 4. The user can set a first user access data (ID1/PW1) to correspond to the restricted category. In other words, the first user access data is utilized to login to the multimedia source 32 so as to manage multimedia data (such as file names AAA, BBB, CCC, and DDD) corresponding to file management access of categories such as restriction, mature audience, parental guidance, and general viewing. Similarly, the user can set a second user access data (ID2/PW2) to correspond to the mature audience category. In other words, the second user access data is utilized to login to the multimedia source 32 so as to manage multimedia data (such as file names BBB, CCC, and DDD) corresponding to the file management access of categories such as mature audience, parental guidance, and general viewing, thus the multimedia data (file name AAA) corresponding the file classification of the restricted category cannot be managed. Similarly, a third user access data (ID3/PW3) can be set to correspond to the mature audience category. In other words, the third user access data is utilized to login to the multimedia source 32 so as to manage multimedia data (such as file names CCC, and DDD) corresponding to the file management access of categories such as parental guidance, and general viewing, thus the multimedia data (file names AAA, and BBB) corresponding the file classification of the restricted category, and mature audience category cannot be managed. Lastly, a fourth user access data (ID4/PW4) can be set to correspond to the general viewing category. In other words, the fourth user access data is utilized to login to the multimedia source 32 so as to manage multimedia data (such as file name DDD) corresponding to the file management access of the general viewing category, thus the multimedia data (file names AAA, BBB, and CCC) corresponding the file classification of the categories such as restricted, mature audience, parental guidance cannot be managed.

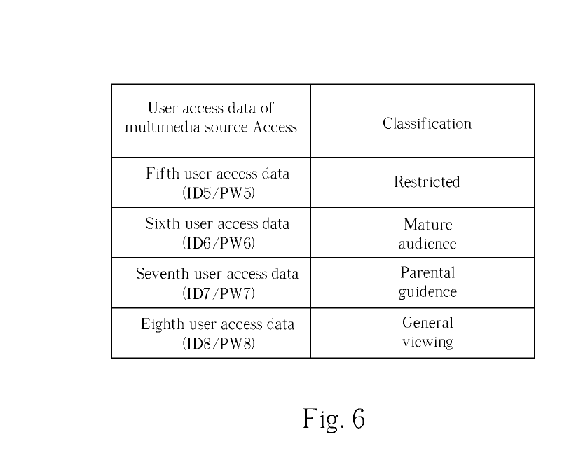

Next the plurality of multimedia sources 32 respectively transmits each user access data and its corresponding access (the data as illustrated in FIG. 5) to the receiving module 36 of the multimedia adapter 30. After the media adapter 30 receives each user access data and its corresponding access, the media adapter 30 will store each user access data and its corresponding access to the memory 44. Furthermore, the user can set the input interface 38 of the media adapter 30 to store the user access data and corresponding relationship of its corresponding access to the memory 44 after the input interface 38 receives the user access data and its corresponding access. For example, please refer to FIG. 6. FIG. 6 illustrates a diagram of an input interface 38 receiving an user access data and its corresponding access, where a fifth user access data (ID5/PW5) corresponds to the restriction category, a sixth user access data (ID6/PW6) corresponds to the mature audience category, a seventh user access data (ID7/PW7) corresponds to the parental guidance category, and an eighth user access data (ID8/PW8) corresponds to the general viewing category.

Next, the user can set service items provided by the plurality of multimedia sources 32. The setting method can be achieved by directly setting the service items at the multimedia source 32 end, or by setting the service items provided by each multimedia source 32 through the input interface 38 of the media adapter 30, whereby the setting of the service items can be done by setting the multimedia data type to be managed, for example allowing multimedia data such as the restricted category or MP3 file type to be managed. Next, the plurality of multimedia sources 32 respectively transmits each service item to the media adapter 30.

Next, the user can utilize the input interface to input an user access data to the media adapter 30, where the user access data inputted by the input interface 38 is compliant to the fifth user access data (ID5/PW5), the sixth user access data (ID6/PW6), the seventh user access data (ID7/PW7), or the eight user access data (ID8/PW8) as illustrated in FIG. 6. The control device 46 of the media adapter 30 will then compare the access (as illustrated in FIG. 5) corresponding to the access of the plurality of multimedia sources 32 received by the receiving module 36 that is stored in the memory 44 with the access (as illustrated in FIG. 6) corresponding to the user access data inputted by the input interface 38. For example, when the user utilizes the input interface 38 to input the sixth user access data (ID6/PW6) to the media adapter 30, and as illustrated in FIG. 6 the sixth user access data (ID6/PW6) corresponds to the mature audience category, the control device 46 will compare and confirm that the access corresponding to the access of the plurality of multimedia sources 32 is the user access data of the mature audience category, for example as illustrated in FIG. 5, a multimedia source 32 that corresponds to the user access data of the mature audience category is the second user access data (ID2/PW2), and so each multimedia source 32 can utilize the comparison method to obtain the corresponding user access data. Next, the media adapter 30 can login to each multimedia source 32 to access the accessible multimedia data according to the user access data corresponding to each multimedia source 32 obtained from the above-mentioned comparison result and the service items provided by each multimedia source 32. As presented in the above example, the media adapter 30 can utilize the second user access data (ID2/PW2) to login to the corresponding multimedia source 32 of FIG. 5, and the media adapter 30 can manage the multimedia data of the service that is opened according to the corresponding service items provided by the multimedia source 32 of FIG. 5. The method of managing multimedia data includes the media adapter 30 respectively managing each multimedia source 32 to transmit the multimedia data corresponding to the access to the display device 34 according to the user access data corresponding to each multimedia source 32 obtained from the above-mentioned comparison result and the service items provided by each multimedia source 32 so as to provide the multimedia data of the access corresponding to an user access data inputted to be watched by the user.

In comparison to the conventional method of utilizing of managing the multimedia data stored in the plurality of multimedia sources and related media adapter, the method and corresponding media adapter of the present invention can combine the setting of multi-user access data and the corresponding multi-access at the media adapter end, and the user access data corresponding to each multimedia source can be obtained through the comparison of the access set at the media adapter and the access corresponding to the user access data of each multimedia source, then the corresponding user access data is utilized to login to each multimedia source to manage the multimedia data stored in the multimedia source, hence the user can input a set of user access data at the media adapter to login to each multimedia source so as to manage the multimedia data stored in each multimedia source with the access corresponding to the set of user access data, without having to login to each multimedia source with specific corresponding user access data and having the trouble of remembering too many sets of user access data corresponding to each multimedia source. Therefore, the trouble of logging in to each multimedia source with each specific user access data is avoided. Hence, the method for utilizing a media adapter to manage multimedia data stored in a plurality of multimedia sources is more innovative.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for utilizing a media adapter to manage multimedia data stored in a plurality of multimedia sources, the method comprising:
(a) the media adapter receiving user access data;
(b) obtaining access corresponding to the user access data;
(c) setting the access corresponding to the user access data of the plurality of multimedia sources;
(d) comparing the access obtained in step (b) with the access obtained in step (c); and
(e) the media adapter respectively managing the multimedia data stored in the plurality of multimedia sources according to a comparison result in step (d).

2. The method of claim 1 wherein step (a) comprises the media adapter receiving a user name and password.

3. The method of claim 1 further comprising the plurality of multimedia sources respectively transmitting the user access data of the plurality of multimedia sources and corresponding authority data to the media adapter.

4. The method of claim 1 further comprising the plurality of multimedia sources respectively transmitting service items provided by the plurality of multimedia sources to the media adapter.

5. The method of claim 4 further comprising the plurality of multimedia sources setting the service items provided by the plurality of multimedia sources.

6. The method of claim 4 further comprising the media adapter respectively setting the service items provided by the plurality of multimedia sources.

7. The method of claim 4 further comprising the media adapter respectively logging in to the plurality of multimedia sources with the access of step (c) being compliant to the access corresponding to the user access data obtained in step (b); wherein step (e) respectively manages the multimedia data stored in the plurality of multimedia sources according to the access obtained in step (b) and the service items provided by the plurality of multimedia sources.

8. The method of claim 1 further comprising the media adapter respectively logging in to the plurality of multimedia sources with the access of step (c) being compliant to the access corresponding to the user access data obtained in step (b); wherein step (e) respectively manages the multimedia data stored in the plurality of multimedia sources according to the access obtained in step (b).

9. The method of claim 1 further comprising the plurality of multimedia sources respectively setting the access corresponding to the user access data of the plurality of multimedia sources.

10. The method of claim 1 further comprising the media adapter setting the access corresponding to the user access data received by the media adapter in step (a).

11. The method of claim 1 wherein steps (e) comprises the media adapter respectively managing the plurality of multimedia sources to transmit the multimedia data to a display device according to a comparison result of step (d).

12. A media adapter capable of managing multimedia data stored in a plurality of multimedia sources, the media adapter comprising:
an input interface for inputting user access data;
a receiving module for receiving the user access data and corresponding access data transmitted from the plurality of multimedia sources;
memory for storing the user access data and corresponding access data; and
a control device for comparing access corresponding to the user access data of the plurality of multimedia sources received by the receiving module stored in the memory with access corresponding to the user access data inputted by the input interface, and for logging in to manage the multimedia data stored in the plurality of multimedia sources according to a comparison result.

13. The media adapter of claim 11 wherein the input interface is an on screen display (OSD).

14. The media adapter of claim 11 comprising:
a decoding module for decoding the multimedia data transmitted from the plurality of multimedia sources to generate a signal receivable by a display device; and
an output module for outputting the signal generated by the decoding module to the display device.

15. The media adapter of claim 11 wherein one of the multimedia sources is a computer.

16. The media adapter of claim 11 wherein one of the multimedia sources is a DVD player.
